(19) United States
(12) Patent Application Publication
(10) Pub. No.: US 2008/0278617 A1
(43) Pub. Date: Nov. 13, 2008

(54) Image capturing device module, manufacturing method of the image capturing device module, and electronic information device

(75) Inventors: Yoshinori Tanida, Hiroshima (JP); Fujio Tanaka, Nara (JP); Katsuitsu Nishida, Kyoto (JP)

Correspondence Address: Edward Angell Palmer & Dodge LLP, P.O. Box 55874, Boston, MA, 02205, US

(73) Assignee: Sharp Kabushiki Kaisha, Osaka-shi (JP)

(21) Appl. No.: 12/152,155

(22) Filed: May 12, 2008

(30) Foreign Application Priority Data
May 10, 2007 (JP) 2007-126102

(51) Int. Cl. H04N 5/225

(52) U.S. Cl. 348/340; 348/E05.024

(57) ABSTRACT

An image capturing device module is disclosed. The image capturing device module includes an image capturing device provided on a base circuit substrate; a translucent member adhered to the image capturing device with a first adhesive to cover an upper part of an effective pixel region in the image capturing device; a lens body including a lens portion that focuses light into the effective pixel region in the image capturing device and a support portion that is translucent and is provided around the lens portion to expose an upper part of the lens portion; and a non-translucent molding resin that molds the image capturing device, the translucent member, and the lens body, with the upper part of the lens portion being exposed.

This Nonprovisional Application claims priority under 35 U.S.C. §119(a) on Patent Application No. 2007-126102 filed in Japan on May 10, 2007, the entire contents of which are hereby incorporated by reference.

### BACKGROUND OF THE INVENTION

1. Field of the Invention

The present invention relates to an image capturing device module mounted to a cell phone, a notebook computer and the like to realize a camera function or an image capturing device module used as a miniature image sensor in a surveillance camera and the like; a manufacturing method of the image capturing device module; and an electronic information device using the image capturing device.

2. Description of the Related Art

An image capturing device, such as a CCD image capturing device and a CMOS image capturing device, for converting image information into an electric signal is used in a cell phone and the like to realize a camera function, or alternatively, it is used as a miniature image sensor in a surveillance camera and the like. In general, such an image capturing device is implemented in a cell phone and the like as an image capturing device module integrated with a lens member for focusing an incident light. It is desirable that the image capturing device module be small and efficiently manufactured.

Reference 1 discloses a configuration, in which a semiconductor chip having an image capturing device formed thereon, a frame member, and a mirror frame member on which a lens member is mounted are positioned mounted on a position reference surface of a ceramic substrate. However, with regard to an image capturing device module having such a configuration, the semiconductor chip is covered by the frame member and the frame member is covered by the mirror frame member, resulting in having a large number of parts and being large in size. Further, a problem arises where such a configuration is not efficiently manufactured.

In addition, Reference 2 discloses an image capturing device module, in which a translucent cover member is integratedly provided on an upper surface of a solid-state image capturing device that is provided on a semiconductor substrate; and a lens holding assembly having a lens is provided in such a manner to cover the solid-state image capturing device and the translucent cover member. However, the image capturing device module of this type also has a configuration in which the solid-state image capturing device and the translucent cover member are covered by the lens holding assembly, thereby, this configuration results in having a large number of parts and being large in size. Further, such a configuration is not efficiently manufactured.

Reference 3 discloses an image capturing device module, in which a housing having an IR filter provided therein is arranged in such a manner to cover an image sensor, and a holder having a lens is provided on the housing. However, even this image capturing device module may have a large number of parts and may be large in size due to the use of the housing. Moreover, a step-like structure for determining the position of the holder needs to be formed on the upper surface of the housing, resulting in a problem that this module is not easy to manufacture.

Further, Reference 4 discloses an image capturing device module, in which a semiconductor chip adhered on a substrate is covered with a resin molding portion that is formed in a box shape; and a lens tube having a lens attached thereto is provided on the resin molding portion. However, the image capturing device module with such a configuration may have a large number of parts and may be large in size as well because the lens is attached to the lens tube. Moreover, a step-like structure and the like needs to be formed on the upper surface of the resin molding portion to determine the position of the lens tube, resulting in a problem that this module is not easy to manufacture.

An easily manufactured small-sized image capturing device module has been developed in order to solve the problems with the conventional techniques described above. FIG. 3 is a cross sectional view showing a diagrammatical configuration of such a conventional image capturing device module. This image capturing device module includes an image capturing device 22a that is die-bonded on a base circuit substrate 21a, the image capturing device 22a being wire-bonded to a circuit provided on the base circuit substrate 21a with a gold wire 23, which is a bonding wire. An IR (Infrared Ray) cut glass 24 is attached on the image capturing device 22a with an adhesive 25. The IR cut glass 24 is configured in such a manner that an IR cut filter is affixed on a glass body portion that is configured in a cuboid shape. The IR cut glass 24 is mounted in an opposing state against an effective pixel region in the image capturing device 22a, the opposing state forming a predetermined space separated from the effective pixel region in the image capturing device 22a, by the adhesive 25 provided along the entire circumference surrounding the effective pixel region in the image capturing device 22a.

The IR cut glass 24 is encapsulated with a non-translucent molding resin 26 together with the image capturing device 22a and the gold wire, which is a bonding wire, so as to the upper surface of the IR cut glass 24 is exposed. The upper surface of the molding resin 26 is parallel to the upper surface of the IR cut glass 24 at a level lower than the upper surface of the IR cut glass 24.

A cylinder shaped lens holder 27 is arranged on the upper surface of the molding resin 26 to cover the upper surface of the IR cut glass 24. The cylinder shaped lens holder 27 is open in its lower end surface and is adhered to the upper surface of the IR cut glass 24 with an adhesive 28 that is provided along the entire circumference of the lower end surface. A lens support portion 27a is provided on an upper surface of the cylinder shaped lens holder 27, and a lens unit 29 is adjustably mounted at the center of the lens support portion 27a. The lens unit 29 includes a cylinder shaped lens barrel 29b that supports the lens portion 29 and an external circumference surface of the lens barrel 29b and an internal circumference surface of the center of the lens support portion 27a of the lens holder 27 are coupled with each other with a screw. Therefore, the position of the lens portion 29a can be adjusted with respect to the lens holder 27 by rotating the lens barrel 29b of the lens unit 29 against the lens support portion 27a of the lens holder 27.

FIG. 4 is a schematic view showing manufacturing steps of the image capturing device module shown in FIG. 3. The image capturing device module shown in FIG. 3 is manufactured using a semiconductor wafer 22. As shown in FIG. 4(a), a large number of image capturing device portions 22b are formed on the semiconductor wafer 22 in advance, corresponding to respective image capturing devices 22a of the image capturing device modules. Subsequently, each of a plurality of IR cut glasses 24 is adhered with the adhesive 25 in such a manner so as to be opposed to an effective pixel region of each of the image capturing device portions 22b corresponding to respective image capturing device modules. In this case, the adhesive 25 is continuously provided along the entire circumference surrounding an effective pixel region in the image capturing device portion 22b. Therefore, a space is formed between the effective pixel region in the image capturing device portion 21b and a lower surface of the IR cut glass 24 in an airtight manner.

Having reached the state described above, the semiconductor wafer 22 is divided at every image capturing device portion 22b, and each of the image capturing device portions 22b becomes an image capturing device 22a of a corresponding image capturing device module as shown in FIG. 4(b). Subsequently, each of the divided image capturing devices 22a is mounted on a base substrate 21 by die-bonding. A large number of base circuit substrate portions 21b are formed on the base substrate 21, corresponding to respective base circuit substrates 21a of the image capturing device modules. The divided image capturing devices 22a are attached by die-bonding to respective predetermined positions on the base circuit substrate portions 21b of the base substrate 21. Subsequent to die-bonding the image capturing devices 22a to the respective base circuit substrate portions 21b, the base circuit substrate portions 21b and the image capturing devices 22a, which are die-bonded, are wire-bonded with gold wires 23.

Subsequent to the die-bonding and wire-bonding of the image capturing devices 22a to the respective base circuit substrate portions 21b of the base substrate 21, all of the image capturing devices 22a on the base substrate 21 together with the IR cut glass 24 are molded with a non-translucent molding resin 26 as shown in FIG. 4(a). Then, an upper surface of the molding resin 26 is processed to form a flattened surface that is parallel to the upper surface of the IR cut glass 24 so as to expose each of the upper surface of the IR cut glass 24 provided on the base substrate 21.

After the molding resin 26 provided on the base substrate 21 is processed into a predetermined shape, the base substrate 21 and the molding resin 26 together are divided in every base circuit substrate portion 21b on the base substrate 21 along the dividing line A shown as a dotted line in FIG. 4(c). As a result, each image capturing device 22 a having IR cut glass 24 attached therein is formed in such a manner to be encapsulated by the molding resin 26.

Subsequently, as shown in FIG. 4(d), the lens holder 27 is adhered with the adhesive 28 on the flat upper surface of the cut off molding resin 26 in such a manner to accommodate the IR cut glass 24 inside the lens holder 27. Then, the lens unit 29 is coupled to the lens support portion 27a on the upper end surface of the lens holder 27 with a screw. In this case, the position of the lens portion 29a is adjusted with respect to the image capturing device 22a by rotating the lens barrel 29b of the lens unit 29. As a result, the image capturing device module shown in FIG. 3 is manufactured.

According to the image capturing device module shown in FIG. 3, IR cut glass 24 is directly adhered on the image capturing device 22a with the adhesive 25, and further, the lens unit 29 is directly adhered with the adhesive 28 to the upper surface of the molding resin 26, which is for molding the IR cut glass 24 together with the image capturing device 22a. Therefore, the image capturing device module shown in FIG. 3 can be manufactured with comparative ease. In addition, the IR cut glass 24 is adhered with the adhesive 25 that is provided along the circumference surrounding an effective pixel region in the image capturing device 22a, and further, a space is formed between the effective pixel region in the image capturing device 22a and the lower surface of the IR cut glass 24 with the adhesive 25 in an airtight manner. As a result, it is possible to prevent dust from adhering to the effective pixel region in the image capturing device 22a.

Reference 1: Japanese Laid-Open Publication No. 2000-125212

Reference 2: Japanese Laid-Open Publication No. 2004-296453

Reference 3: Japanese Laid-Open Publication No. 2003-110946

Reference 4: Japanese Laid-Open Publication No. 2005-184630

### SUMMARY OF THE INVENTION

According to the image capturing device module shown in FIG. 3, after the image capturing device 22a and the IR cut glass 24 are molded with a molding resin 26 and they are divided by dicing between the image capturing devices 22a, the lens holder 27 is adhered with the adhesive 28. Such a configuration is taken because there is a possibility of not being able to ensure a space for dicing in between adjacent lens holders 27 if the lens holders 27 are mounted on the respective upper surfaces of the molding resin 26 prior to dividing the molding resin 26. Therefore, the lens holders 27 need to be mounted on the respective upper surfaces of the divided molding resins 26. However, in this configuration, the lens holders cannot be efficiently mounted. Moreover, each of the lens units 29 needs to be mounted to the corresponding lens holder 27 adhered to each image capturing device 22a, resulting in a problem where the mounting and adjusting for the lens unit 29 cannot be efficiently conducted.

The present invention is intended to solve the conventional problem described above, and an objective of the present invention is to provide an image capturing device module that is efficiently manufactured with fewer parts and at a lower cost; a manufacturing method of the image capturing device module; and an electronic information device using the image capturing device.

An image capturing device module according to the present invention includes an image capturing device provided on a base circuit substrate; a translucent member adhered to the image capturing device with a first adhesive to cover an upper part of an effective pixel region in the image capturing device, wherein an upper surface of the translucent member is formed into a flat surface; a lens body including a lens portion that focuses light into the effective pixel region in the image capturing device and a support portion that is translucent and is provided around the lens portion to expose an upper part of the lens portion, wherein a lower surface of the support portion is formed into a flat surface, and wherein a lower surface of the support portion is adhered to the upper surface of the translucent member with a second adhesive; and a non-translucent molding resin that molds the image capturing device, the translucent member, and the lens body, with the upper part of the lens portion being exposed.

Preferably, in an image capturing device module according to the present invention, a space is formed between the effective pixel region in the image capturing device and a lower surface of the translucent member with the first adhesive in airtight manner.

Still preferably in an image capturing device module according to the present invention, the translucent member is an IR cut glass.

A manufacturing method of the image capturing device module according to claim 1 includes the steps of: preparing a semiconductor wafer, in which a plurality of image capturing device portions are formed, each of the plurality of image capturing device portions formed into an image capturing device, and adhering translucent members on the respective image capturing device portions on the semiconductor wafer using a first adhesive; adhering a lens body on an upper surface of the translucent member using a second adhesive; dividing the semiconductor wafer into each of the image capturing device portions to form a plurality of the image capturing devices, wherein the translucent member and the lens body are adhered to each of the image capturing devices; preparing a base substrate having a plurality of base circuit substrate portions formed thereon, each of the plurality of base circuit substrate portions formed into a base circuit substrate, and die-bonding the image capturing device having the translucent member and the lens body adhered thereto to the base circuit portion on the base substrate; performing a molding with the molding resin, so that each upper portion of the respective lens portions in all the lens bodies provided on the base substrate is exposed; and dividing the base substrate into each of the base circuit substrate portions together with the molding resin to form the base circuit substrate.

Preferably, in a manufacturing method of the image capturing device module according to the present invention, the first adhesive is applied continuously along an entire circumference surrounding an effective pixel region in the image capturing device portion in the step of adhering the translucent member.

Still preferably, in a manufacturing method of the image capturing device module according to the present invention, a space is formed between the effective pixel region in the image capturing device portion and a lower surface of the translucent member with the first adhesive in an airtight manner in the step of adhering the translucent member.

Still preferably, in a manufacturing method of the image capturing device module according to the present invention, the translucent member is an IR cut glass.

An electronic information device using the image capturing device according to the present invention as an image input section thereof.

According to the image capturing device module of the present invention, a lens body is adhered on a translucent member that is adhered on an image capturing device with an adhesive, and then the lens body is molded with a molding resin, resulting in fewer parts and smaller size. Further, the image capturing device module of the present invention can be manufactured at a lower cost. In addition, the manufacturing method of the image capturing device module of the present invention significantly improves the working efficiency of mounting a translucent member and a lens body because the translucent member and the lens body are provided at once for an image capturing device portion on a semiconductor wafer, and then the semiconductor wafer is divided in every image capturing device portion. Further, after each image capturing device is mounted on the base substrate and all the image capturing devices are molded at once with a molding resin, the base substrate together with the molding resin is divided, thereby forming the image capturing device module. As a result, the dividing process of the base substrate can be performed at the end of the entire process, which eliminates the necessity of mounting a lens body and the like in a state where the base substrate is already divided, thereby significantly improving the work efficiency.

The electronic information device according to the present invention uses the image capturing device module as an image input section thereof. As a result, the number of the parts used is few and the electronic information device is manufactured at a low cost.

These and other advantages of the present invention will become apparent to those skilled in the art upon reading and understanding the following detailed description with reference to the accompanying figures.

### BRIEF DESCRIPTION OF THE DRAWINGS

FIG. 1 is a cross sectional view showing a diagrammatical configuration of an image capturing device module according to the present invention.

FIGS. 2(a)-(d) respectively are cross sectional views showing manufacturing steps of the image capturing device module according to the present invention shown in FIG. 1.

FIG. 3 is a cross sectional view showing diagrammatical configuration of a conventional image capturing device module.

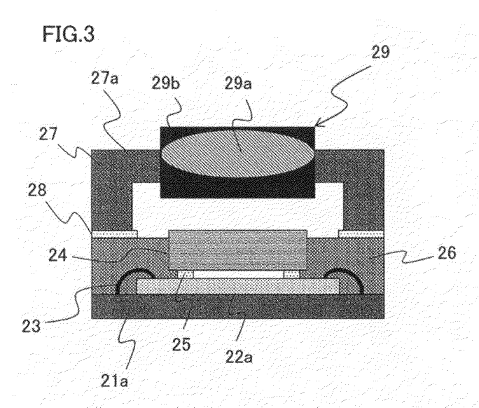

FIGS. 4(a)-(d) respectively are cross sectional views showing manufacturing steps of the image capturing device module shown in FIG. 3.

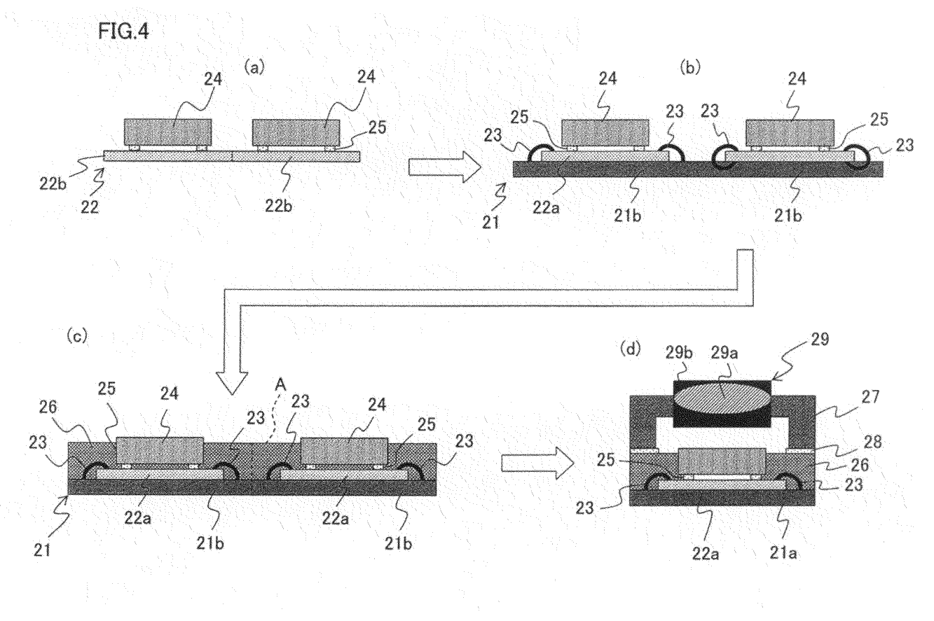

FIG. 5 is a block diagram showing an exemplary schematic structure of an electronic information device using a solid-state image capturing apparatus that includes an image capturing device module according to Embodiment 1 of the present invention for an image capturing section thereof.

| | |
|---|---|
| 11 | base substrate |
| 11a | base circuit substrate |
| 11b | base circuit substrate portion |
| 12 | semiconductor wafer |
| 12a | image capturing device |
| 12b | image capturing device portion |
| 13 | gold line |
| 14 | IR cut glass |
| 15, 18 | adhesive |
| 16 | molding resin |
| 17 | lens body |
| 17a | support portion |
| 17b | lens portion |

### DESCRIPTION OF THE PREFERRED EMBODIMENTS

### Embodiment 1

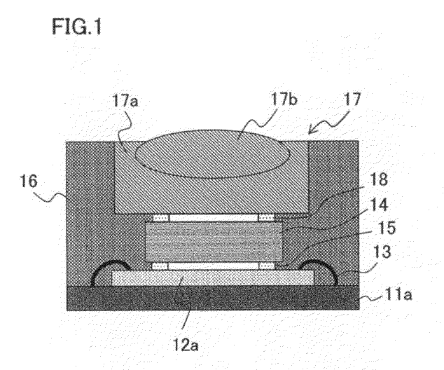

FIG. 1 is a cross-sectional view showing a diagrammatical configuration of an image capturing device module according to the present invention. This image capturing device module includes an image capturing device 12a that is die-bonded on a base circuit substrate 11a. The image capturing device 12a is wire-bonded to the base circuit substrate 11a with a gold wire 13, which is a bonding wire. An IR (Infrared Ray) cut glass 14, which is a translucent member, is mounted above the image capturing device 12a with an adhesive 15. The IR cut glass 14 is configured in such a manner that an upper surface and a lower surface of a cuboid glass body portion are formed into a flat surface respectively and an IR cut filter is affixed to the glass body portion. The IR cut glass 14 is adhered in such a manner that the adhesive 15 that is continuously provided along the entire circumference surrounding an effective pixel region in the image capturing device 12a adheres the flat lower surface of the IR cut glass 14 to an upper surface of the image capturing device 12a. The adhesive 15 encapsulates a space between the flat lower surface of the IR cut glass 14 and the effective pixel region in the image capturing device 12a in an airtight manner.

A lens body 17 is provided above the flat upper surface of the IR cut glass 14 that is adhered by an adhesive 18. The lens body 17 includes a support portion 17a that is formed in a cuboid form with a translucent resin and a lens portion 17b that is provided at the center of the upper portion of the support portion 17a. A part of the lens portion 17b provided in the upper portion of the support portion 17a is protruded from the upper surface of the support portion 17a to refract incident light from above at a predetermined refractive index to focus the light at the effective pixel region in the image capturing device 12a through the support portion 17a and the IR cut glass 14. With regard to the support portion 17a, the upper portion except for the portion with the protruded lens portion 17b, the lower portion and each side portion are formed into a flat surface, and the light transmitted through the lens portion 17b makes a straight advance inside the support portion 17a and is then outputted from the flatly-configured lower surface.

In a plane view, the adhesive 18 is continuously provided along the entire circumference of the peripheral portion on the flat upper surface of the IR cut glass 14, the entire circumference of the peripheral portion corresponding to the circumference surrounding the effective pixel region in the image capturing device 12a, and the lens body 17 is adhered in such a manner that an appropriate space is formed between the lower surface the support portion 17a and the upper surface of the IR cut glass 14. The adhesive 18 encapsulates the space between the flat lower surface of the support portion 17a and the flat upper surface of the IR cut glass in an airtight manner.

A non-translucent molding resin 16 encapsulates the image capturing device 12a on the base circuit substrate 11a, the gold wire 13 functioning as a bonding wire, the IR cut glass 14, and the lens body 17 in such a manner that the upper surface of the support portion 17a of the lens body 17 and the upper portion of the lens portion 17b protruded from the upper surface of the support portion 17a are exposed. The upper surface of the molding resin 16 is a flat surface positioned at the same plane level as the upper surface of the support portion 17a of the lens body 17.

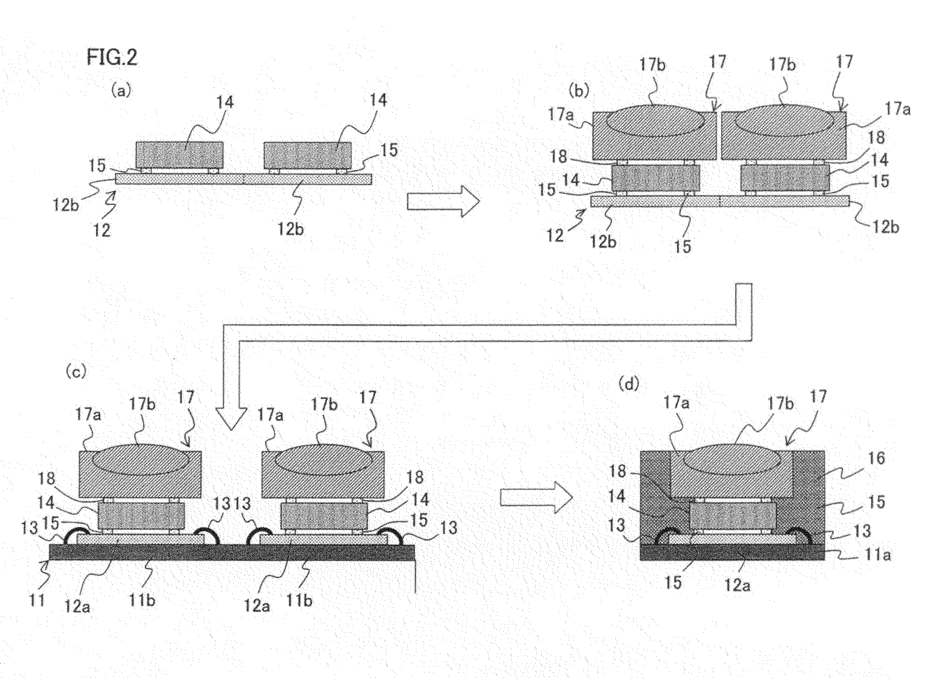

FIG. 2 is a schematic view showing manufacturing steps of the image capturing device module according to the present invention shown in FIG. 1. In order to manufacture the image capturing device module shown in FIG. 1, a semiconductor wafer 12 is prepared as shown in FIG. 12(a). A large number of image capturing device portions 12b are formed in advance, which correspond to respective image capturing devices 12a of the image capturing device modules, on the semiconductor wafer 12. An effective pixel region is provided for each image capturing device portion 12b.

Subsequent to the preparation of the substrate wafer, a predetermined amount of the adhesive 15 is applied at once to the respective image capturing device portion 12b. In this case, a predetermined amount of the adhesive 15 is continuously provided along the entire circumference surrounding an effective pixel region in the image capturing device 12b.

Subsequently, a plurality of IR cut glasses 14 are prepared with the upper and lower surfaces of the IR cut glass being formed into a flat surface. The IR cut glass 14 is positioned in such a manner that the IR cut glass 14 is in an opposed position with the effective pixel region in each image capturing device portion 12 corresponding to the respective image capturing device module, and each IR cut glass 14 is adhered at once to the respective image capturing device portion 12b in the semiconductor wafer 12. In this case, each IR cut glass 14 is pressed at a predetermined press force to the respective image capturing device portion 12b in the semiconductor wafer 12. As a result, each IR cut glass 14 is adhered in such a manner that a predetermined space is formed between each lower surface of the IR cut glass 14 and the corresponding effective pixel region in the image capturing device portion 12b in an airtight manner and further that each lower surface is parallel to the upper surface of the respective image capturing device portion 12b.

Having reached the state described above, the adhesive 18 is applied at once in a predetermined amount on each upper surface of the respective IR cut glass 14 as shown in FIG. 2(b). In this case as well, the adhesive 18 is applied on each upper surface of the respective IR cut glasses 14 only once continuously along the entire circumference of the peripheral portion corresponding to the circumference surrounding an effective pixel region in the image capturing device 12a. Subsequently, a plurality of cuboid lens bodies 17 with a lens portion 17b protruded from the upper surface is adhered above the IR cut glass 14 with the adhesive 18. In this case as well, all of the lens bodies 17 are pressed at a predetermined press force to the respective upper surfaces of the IR cut glass 14. As a result, each lens body 17 is adhered in such a manner that a predetermined space is formed between each lower surface of the lens body 17 and the upper surface of the respective IR cut glass 14 in an airtight manner and further that each lower surface is parallel to the upper surface of the respective IR cut glass 14. In addition, the lens body 17 is adjusted so that the lens 17b is positioned at a predetermined position for the effective pixel region in the respective image capturing device portion 12b.

When the lens body 17 is attached above the upper surface of the IR cut glass 14 in this manner, each base circuit substrate portion 11b on the base substrate 11 and the image capturing device 12a that is die-bonded on the respective base circuit substrate portion 11b are wire-bonded with the gold wire 13. Then, each image capturing device 12 on the base substrate 11, each of all the gold wires 13 functioning as a bonding wire, each IR cut glass 14 provided above the respective image capturing device 12 and the lens body 17 provided above the respective IR cut glass 14 are molded at once with a non-translucent molding resin 16. The upper surface of the molding resin 16 is processed in such a manner that the flat upper surface of the support portion 17a of the lens body 17 and the lens portion 17b protruded from the upper surface of the support portion 17a are exposed. The upper surface of the molding resin 16 is flattened by a processing method, such as a chemical mechanical polishing and the like.

When each image capturing device 12a on the base substrate 11 is molded together with the IR cut glass 14 and the lens body 17, the base substrate 11 together with the molding resin 16 is divided at each base circuit substrate portion 11b in the base substrate 11 by dicing. As a result, the image capturing device module according to the present invention is formed as shown in FIG. 2(d). In this case, each of the base circuit portions 11b may be formed close to each other since a space for dicing the molding resin 16 has only to be formed in between lens bodies 17 that are adjacent to each other. As a result, the base circuit substrate portion 11b is formed with a good yield rate in the base substrate 11.

With regard to the image capturing device module according to the present invention that is formed as described above, the light coming into the lens portion 17b of the lens body 17 exposed from the molding resin 16 is focused by the lens portion 17b and is emitted to the effective pixel region in the image capturing device 12a through the support portion 17a and the IR cut glass 14 with infrared rays cut off. The IR cut glass 14 is adhered to the image capturing device 12a with the adhesive 15 provided along the periphery of the effective pixel region in the image capturing device 12a. In addition, since the lens body 17 is also adhered above the upper surface of the IR cut glass 14 with the adhesive 18 provided along the periphery of the effective pixel region in the image capturing device 12a, the incident light into the lens portion 17b of the lens body 17 efficiently comes into the effective pixel region in the image capturing device 12a without being affected by the adhesive 15 or 18.

Further, since the IR cut glass 14 covers the effective pixel region through the space in an airtight manner formed by the adhesive 18 provided along the circumference of the effective pixel region in the image capturing portion 12b, there is no possibility of dust adhering to the effective pixel region. Similarly, since the lens body 17 covers the region in the upper surface of the IR cut glass 14, in which the light comes, through the space in an airtight manner, there is no possibility of dust adhering to the upper surface of the IR cut glass 14.

Further, the image capturing device module according to the present invention does not need a lens holder for maintaining a lens unit since the image capturing device module uses the lens body 17, in which the lens portion 17b and the support portion 17a are integrated, and has a configuration to mount the lens body 17 directly above the IR cut glass 14, which is a translucent member. As a result, the number of the parts used in the image capturing device module will be fewer and the entire module can be not only miniaturized but also provided at a lower cost.

In addition, according to the manufacturing steps of the image capturing device module of the present invention, every piece of the IR cut glass 14 is mounted above the corresponding semiconductor wafer 12 at once, and further, lens bodies 17 are mounted above every IR cut glass 14 at once. Therefore, the position for each lens body 17 can be adjusted in the state where all the lens bodies 17 have been mounted on the semiconductor wafer 12, thereby effectively adjusting each lens body 17.

Further, the semiconductor wafer 12 is divided into image capturing devices 12a and each of the image capturing devices 12a is mounted on the corresponding base substrate 11 after the IR cut glass 14 and the lens body 17 are mounted on each image capturing device portion 12b, and therefore no other specific work is necessary for each of the divided image capturing devices 12a except for mounting it on the base substrate 11, thereby significantly improving the workability.

### Embodiment 2

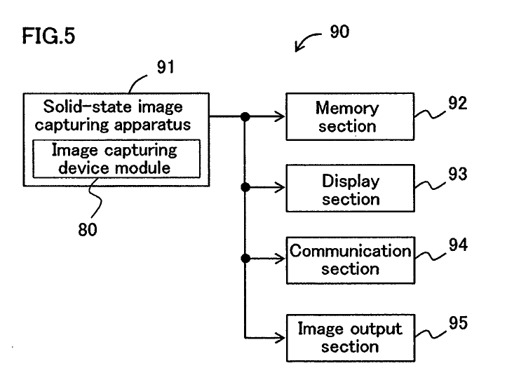

FIG. 5 is a block diagram showing an exemplary schematic structure of an electronic information device, as Embodiment 2 of the present invention, using a solid-state image capturing apparatus that includes an image capturing device module 80 according to Embodiment 1 of the present invention for an image capturing section thereof.

In FIG. 5, the electronic information device 90 according to Embodiment 2 includes: a solid-image capturing apparatus 91 according to Embodiment 1 for performing various signal processes on an image capturing signal from the image capturing device module according to Embodiment 1 described above in order to obtain color image signals; a memory section 92 (e.g., recording media) for data-recording a color image signal, which is obtained by performing a predetermined signal process on the color image signal from the solid-state image capturing apparatus 91 after a predetermined signal process is performed on the color image signal for recording; a display section 93 (e.g., liquid crystal display device) for displaying this color image signal on a display screen (e.g., liquid crystal display screen) after a predetermined signal process is performed on the color image signal from the solid-state image capturing apparatus 91 for display; and a communication section 94 (e.g., transmitting and receiving device) for communicating the color image signal after a predetermined signal process is performed on the color image signal from the solid-stage image capturing apparatus 91 for communication. Further, the electronic information device 90 can include not only the solid-image capturing apparatus 91, but also at least any of the memory section 92, the display section 93, the communication section 94, and an image output section 95 (e.g. printer).

Any of the following can be considered as the electronic information device 90: a digital camera (e.g., digital video camera, digital still camera), an image input camera (e.g., monitoring camera, door intercom camera, car-mounted camera and camera for television telephone), and an image input device (e.g., scanner, facsimile, cell phone device equipped with camera, and personal digital assistant (PDA)).

Therefore, according to Embodiment 2, based on a color image signal from the solid-state image capturing apparatus 91, it is possible to perform a variety of data processes in an excellent manner, such as displaying the color image signal on a display screen in an excellent manner, printing out (printing) the color image signal on a paper using the image output section 95 in an excellent manner, communicating the color image signal as communication data in a wired or wireless manner in an excellent manner, and performing a predetermined compression process on the color image signal and storing it in the memory section 92.

As described above, the present invention is exemplified by the use of its preferred embodiment. However, the present invention should not be interpreted solely based on the embodiment described above. It is understood that the scope of the present invention should be solely interpreted based on the claims. It is also understood that those skilled in the art can implement equivalent scope of technology, based on the description of the present invention and common knowledge from the description of the detailed preferred embodiment of the present invention. Furthermore, it is understood that any patent, any patent application and any references cited in the present specification should be incorporated by reference in the present specification in the same manner as the contents are specifically described therein.

### INDUSTRIAL APPLICABILITY

It is possible to miniaturize an image capturing module used by being mounted in a cell phone and the like and provide the image capturing module at a lower cost. It is also possible to effectively manufacture the image capturing module.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. An image capturing device module, comprising:
an image capturing device provided on a base circuit substrate;
a translucent member adhered to the image capturing device with a first adhesive to cover an upper part of an effective pixel region in the image capturing device, wherein an upper surface of the translucent member is formed into a flat surface;
a lens body including a lens portion that focuses light into the effective pixel region in the image capturing device and a support portion that is translucent and is provided around the lens portion to expose an upper part of the lens portion, wherein a lower surface of the support portion is formed into a flat surface, and wherein a lower surface of the support portion is adhered to the upper surface of the translucent member with a second adhesive; and
a non-translucent molding resin that molds the image capturing device, the translucent member, and the lens body, with the upper part of the lens portion being exposed.

2. An image capturing device module according to claim 1, wherein a space is formed between the effective pixel region in the image capturing device and a lower surface of the translucent member with the first adhesive in airtight manner.

3. An image capturing device module according to claim 1, wherein the translucent member is an IR cut glass.

4. A manufacturing method of the image capturing device module according to claim 1, comprising the steps of:
preparing a semiconductor wafer, in which a plurality of image capturing device portions are formed, each of the plurality of image capturing device portions formed into an image capturing device, and adhering translucent members on the respective image capturing device portions on the semiconductor wafer using a first adhesive;
adhering a lens body on an upper surface of the translucent member using a second adhesive;
dividing the semiconductor wafer into each of the image capturing device portions to form a plurality of the image capturing devices, wherein the translucent member and the lens body are adhered to each of the image capturing devices;
preparing a base substrate having a plurality of base circuit substrate portions formed thereon, each of the plurality of base circuit substrate portions formed into a base circuit substrate, and die-bonding the image capturing device having the translucent member and the lens body adhered thereto to the base circuit portion on the base substrate;
performing a molding with the molding resin, so that each upper portion of the respective lens portions in all the lens bodies provided on the base substrate is exposed; and
dividing the base substrate into each of the base circuit substrate portions together with the molding resin to form the base circuit substrate.

5. A manufacturing method of the image capturing device module according to claim 4, wherein the first adhesive is applied continuously along an entire circumference surrounding an effective pixel region in the image capturing device portion in the step of adhering the translucent member.

6. A manufacturing method of the image capturing device module according to claim 5, wherein a space is formed between the effective pixel region in the image capturing device portion and a lower surface of the translucent member with the first adhesive in an airtight manner in the step of adhering the translucent member.

7. A manufacturing method of the image capturing device module according to claim 4, wherein the translucent member is an IR cut glass.

8. An electronic information device using the image capturing device according to claim 1 as an image input section thereof.
